(19) United States
(12) Patent Application Publication
(10) Pub. No.: US 2012/0048961 A1
(43) Pub. Date: Mar. 1, 2012

(54) DUAL SOFT PASSAGE NOZZLE

(75) Inventors: Kapil Kumar Singh, Rexford, NY (US); Fei Han, Clifton Park, NY (US); Shiva Srinivasan, Greer, SC (US); Kwanwoo Kim, Greer, SC (US)

(73) Assignee: GENERAL ELECTRIC COMPANY, Schnectady, NY (US)

(21) Appl. No.: 12/872,037

(22) Filed: Aug. 31, 2010

(51) Int. Cl. B05B 17/04; B05B 1/14

(52) U.S. Cl. 239/11; 239/553

(57) ABSTRACT

The present application provides a fuel nozzle system. The fuel nozzle system may include a pre-orifice for a first pressure drop, a captured response volume in communication with the pre-orifice, a post-orifice in communication with the captured response volume for a second pressure drop, and a secondary fuel passage downstream of the post-orifice for a third pressure drop. The second pressure drop is less than the first pressure drop and the third pressure drop is less than the second pressure drop.

### TECHNICAL FIELD

The present application relates generally to gas turbine engines and more particularly relates to a dual soft passage nozzle for low combustion dynamics in premixed, low emissions gas turbines and the like.

### BACKGROUND OF THE INVENTION

Premixing of fuel and air can lead to unsteady combustion when compared to conventional non-premixed combustion systems. The generally unsteady heat released from premixed combustion in closed environments such as a gas turbine combustor may be coupled with the natural acoustic modes of the enclosure or the combustor. The combustion may respond to pressure variations that may set up an acoustic feed back cycle therein. Such a feed back cycle may have the potential to generate high amplitude pressure fluctuations. These pressure fluctuations, known as combustion dynamics or combustion instabilities, may be catastrophic to the combustor and the overall gas turbine engine.

With the expanded use of premixed, low emissions combustion systems, the issue of combustion dynamics has become significant. Various techniques have attempted to address and limit combustion dynamics. These techniques have included alterations or modification to the generation mechanisms, alterations to the geometrical or acoustical properties of the combustor, and using active or passive methods to control and/or suppress the generated dynamics. A further approach, involving fuel line response to smooth out such instability, is described in more detail below. Other types of control and suppression methods also may be known.

There is thus a desire for an improved fuel nozzle system and methods of operating the same so as to control and suppress combustion dynamics in premixed, low emissions gas turbines and the like. Such fuel nozzle systems and methods preferably should reduce such combustion dynamics while providing continued operation reliability and efficiency.

### SUMMARY OF THE INVENTION

The present application thus provides a fuel nozzle system. The fuel nozzle system may include a pre-orifice for a first pressure drop, a captured response volume in communication with the pre-orifice, a post-orifice in communication with the captured response volume for a second pressure drop, and a secondary fuel passage downstream of the post-orifice for a third pressure drop. The second pressure drop is less than the first pressure drop and the third pressure drop is less than the second pressure drop.

The present application further provides a method of flowing fuel through a fuel nozzle system. The method may include the steps of flowing the fuel across a first pressure drop in a first orifice, flowing the fuel through a captured response volume, flowing the fuel across a second pressure drop in a second orifice wherein the second pressure drop is less than the first pressure drop, and flowing the fuel across a third pressure drop in a secondary passage wherein the third pressure drop is less than the second pressure drop.

The present application further provides a fuel nozzle system. The fuel nozzle system may include a first fuel orifice for a first pressure drop, a captured response volume in communication with the first fuel orifice, a second fuel orifice in communication with the captured response volume for a second pressure drop, and one or more secondary fuel passages downstream of the second fuel orifice for a third pressure drop. The second pressure drop is less than the first pressure drop and the third pressure drop is more or less than the second pressure drop.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a gas turbine engine.

FIG. 2 is a partial side cross-sectional view of a known two-stage fuel nozzle.

FIG. 3 is a schematic view of a dual soft passage nozzle as may be described herein.

### DETAILED DESCRIPTION

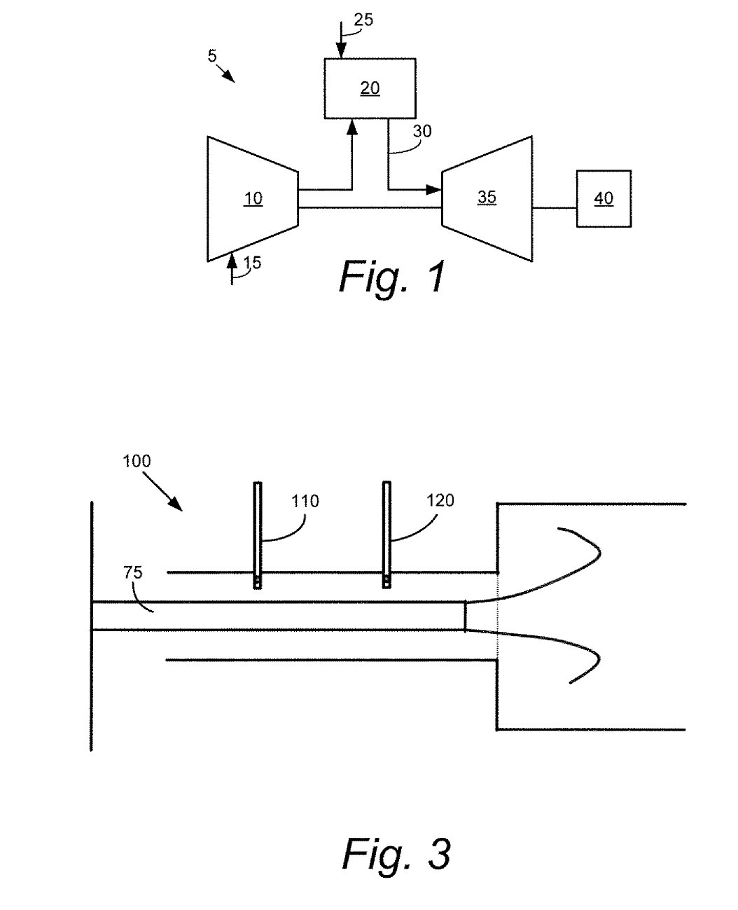

Referring now to the drawings, in which like numerals refer to like elements throughout the several views, FIG. 1 shows a schematic view of a gas turbine engine 5 as may be described herein. The gas turbine engine 5 may include a compressor 10. The compressor 10 compresses an incoming flow of air 15. The compressor 10 delivers the compressed flow of air 15 to a combustor 20. The combustor 20 mixes the compressed flow of air 15 with a compressed flow of fuel 25 and ignites the mixture to create a flow of combustion gases 30. Although only a single combustor 20 is shown, the gas turbine engine 5 may include any number of combustors 20. The flow of combustion gases 30 are in turn delivered to a turbine 35. The flow of combustion gases 30 drives the turbine 35 so as to produce mechanical work. The mechanical work produced in the turbine 35 drives the compressor 10 and an external load 40 such as an electrical generator and the like.

The gas turbine engine 5 may use natural gas, various types of syngas, and other types of fuels. The gas turbine engine 5 may be one of any number of different premixed, low emission gas turbine engines offered by General Electric Company of Schenectady, N.Y. or otherwise. The gas turbine engine 5 may have other configurations and may use other types of components. Other types of gas turbine engines also may be used herein. Multiple gas turbine engines 5, other types of turbines, and other types of power generation equipment may be used herein together.

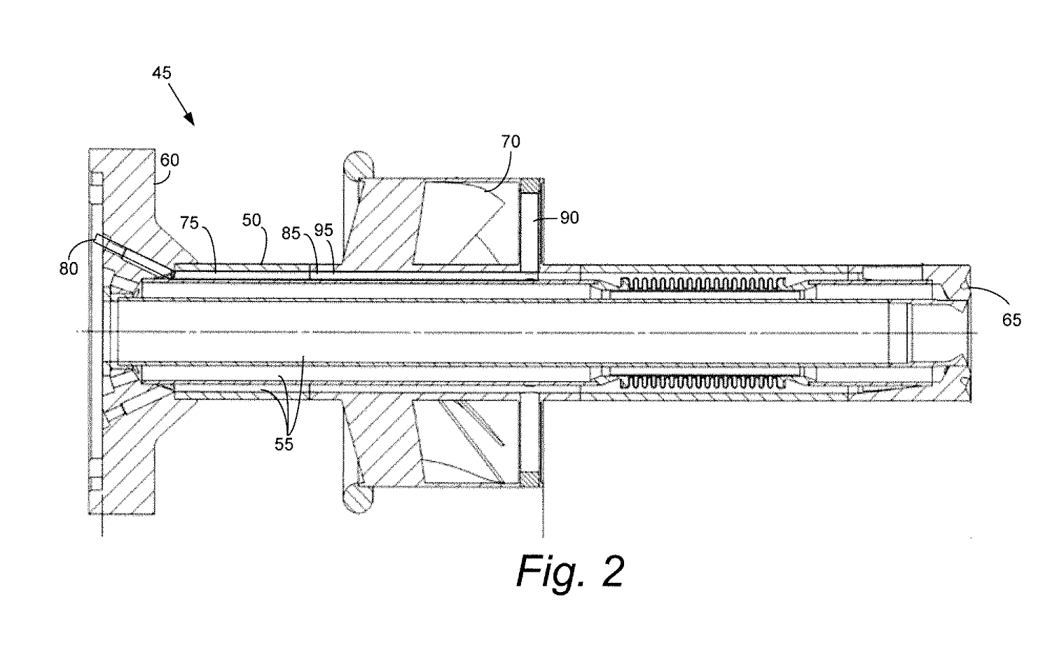

FIG. 2 shows one example of a known two-stage fuel nozzle 45 or a “soft” nozzle. The basic configuration of the components of the soft nozzle 45 may include a sleeve 50 with a number of conduits 55 extending therethrough. The conduits 55 provide flow paths for the flows of fuel, air, and other types of gases. For example, nitrogen and other types of inert gases also may flow therethrough. The conduits 55 may extend from a cover assembly 60, along the length of the nozzle 45, and end about a nozzle tip 65. One or more swirlers 70 also may be positioned about the sleeve 50 and in communication with one or more of the conduits 55. Other nozzle configurations may be used herein.

A fuel gas, such as natural gas and the like, may be supplied to one or more of the conduits 55 as fuel conduits 75. The fuel conduits 75 may include one or more first or pre-orifices 80 positioned about an upstream end of the nozzle 45. The pre-orifices 80 may have a relatively high pressure drop therethrough. The fuel conduits 75 then may extend along the nozzle 45 via an annular chamber 85 and into one or more second or post-orifices 90. The post-orifices 90 may be positioned about the swirlers 70 or otherwise. The post-orifices 90 may have a relatively low pressure drop therethrough and, hence, may be described as a “soft” passage with smaller fluxuations therethrough. Other nozzle configurations may be used herein.

The volume between the pre-orifices 80 and the post-orifices 90, respectively, may form a captured response volume 95 about the annular chamber 85. The fuel gas may enter the fuel conduits 75, pass through or about the pre-orifices 80, pass into the captured response volume 95, pass through or about the post-orifices 90 about the swirlers 70, and into a downstream premixer zone. The high pressure drop normally taken at the gaseous fuel exit in conventional fuel nozzles thus may be spaced upstream from the premixer zone and the post-orifices 90 to the captured response volume 95 and the pre-orifices 80.

Assuming a pressure disturbance in the premixer zone that may result in a lower premixer zone pressure, the air supply to the premixer zone through the openings in the combustor 20 may increase. Such a response may be quick and may have a small phase angle in relation to the phase angle of the pressure disturbance. If a conventional high pressure gas fuel nozzle was located about the premixer fuel discharge orifice, the fuel flow also would likewise tend to increase in response to the lowering of the premixer pressure. The response of the fuel supply to such a decrease in pressure in the premixer zone, however, may be longer than the response time of the air pressure such that a mismatch in the phase angles between the fuel and the air pressure responses may develop.

The high pressure drop in the fuel passages herein is thus taken at the pre-orifices 80 such that the pressure in the response volume 95 may be substantially closer to the compressor discharge pressure. If the pressure drop through the combustor 20 is substantially the same as the low pressure drop across the post-orifices 90, then the phase angles, responsive to the pressure forcing function, also may be substantially matched. By matching the phase angles, the fuel/air concentration remains substantially at a constant, notwithstanding the pressure disturbance in the fuel and air delivery systems. As a result, the oscillation cycles may be substantially minimized herein.

By way of example, nozzle pressure fluctuations may be evaluated in terms of mass flow rate differentials or pressure differentials for the fuel flow and the air flow:

$$\frac{{φ}^{′}}{\overline{φ}} = \frac{{m}_{f}^{′}}{{\overline{m}}_{f}} - \frac{{m}_{a}^{′}}{{\overline{m}}_{a}}$$

$$\frac{{φ}^{′}}{\overline{φ}} = \frac{{p}_{fup}^{′} - {p}_{d}^{′}}{2 Δ {\overline{P}}_{f}} - \frac{{p}_{aup}^{′} - {p}_{d}^{′}}{2 Δ {\overline{P}}_{a}}$$

If the air pressure drop across, for example, the swirlers 70 is the same as the fuel pressure drop across, for example, the post-orifices 90, then:

$$Δ {\overline{P}}_{f} = Δ {\overline{P}}_{a}$$

$$\frac{{φ}^{′}}{\overline{φ}} = \frac{{p}_{fup}^{′} - {p}_{aup}^{′}}{2 Δ {\overline{P}}_{f}}$$

Thus, if the upstream air pressure fluctuations and the upstream fuel line pressure fluctuations are small or the same, then:

$$\frac{{φ}^{′}}{\overline{φ}} = \frac{0}{2 Δ {\overline{P}}_{f}} = 0$$

The goal herein is thus to limit the overall pressure fluctuations across the nozzle to an extent greater than that currently possible with the nozzle 45 described above and with similar designs.

FIG. 3 thus is a schematic view of a fuel nozzle 100 as may be described herein. The fuel nozzle 100 may include a primary soft passage 110. The primary soft passage 110 may be similar to the post-orifices 90 described above. The fuel nozzle 100 also may include one or more secondary soft passages 120. The secondary soft passages 120 may be positioned downstream or upstream of the primary soft passage 130. Any number of secondary soft passages 120 may be used herein.

The fuel nozzle 100 thus modifies the nozzle 45 described above for even lower combustion dynamics. Specifically, the fuel nozzle 100 includes the pre-orifices 80 and the two or more soft passages 110, 120 to provide additional tuning/matching capability of the pressure drop in the fuel flow so as to match the pressure drop across the air flow. The secondary soft passage 120 and the other soft passages may be utilized to flow only the required amount of fuel/fuel-mixture to achieve a specific pressure drop so as substantially to reduce or nullify the remaining pressure drop mismatch from the original primary soft passage 110.

In addition, the secondary soft passages 120 provide an increased tuning capability so as to increase the operating range of the fuel nozzle 100. Moreover, the secondary soft passages 120 may be used with a specified fuel/inert flow so as to alter the acoustic characteristics and hence improve and control combustion dynamics performance. Operation of the secondary soft passages 120 and/or splitting the flow between the primary and the secondary soft passages 110, 120 may be predetermined and/or controlled in real time via a combustion dynamics analysis (CDA) tool or otherwise. Use of the CDA tool algorithm may lead to enhanced overall performance of the fuel nozzle 100 and the like via wider effective operating boundaries and lower combustion dynamics. Such improved operational boundaries with lower dynamics also should lead to a longer life expectancy. The fuel nozzle 100 likewise may avoid unscheduled shutdowns. Other types of control systems and methods also may be used herein

Although the pressure drop across the secondary soft passages 120 generally will be less that the pressure drop across the primary soft passage 110 and otherwise, the pressure drop may be greater. Specifically, the fuel nozzle 100 also may provide for an independent secondary fuel supply either upstream or downstream of the original flow of fuel 25. This independent fuel supply may include a third pressure drop across its pre-orifice 80, a captured response volume 95 in communication with the secondary pre-orifice 110 and post-orifice 120, and a fourth pressure drop across its post-orifice 120. The secondary post-orifice 120 thus may be totally independent of the existing pre-orifice 110. As such, the additional secondary soft passages 120 may have their own pre-orifices different from the pre-orifices 80.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A fuel nozzle system, comprising:
a pre-orifice for a first pressure drop;
a captured response volume in communication with the pre-orifice;
a post-orifice in communication with the captured response volume for a second pressure drop;
wherein the second pressure drop is less than the first pressure drop; and
a secondary fuel passage downstream of the post-orifice for a third pressure drop;
wherein the third pressure drop is less than the second pressure drop.

2. The fuel nozzle system of claim 1, wherein the pre-orifice comprises a plurality of pre-orifices.

3. The fuel nozzle system of claim 1, wherein the post-orifice comprises a plurality of post-orifices.

4. The fuel nozzle system of claim 1, wherein the captured response volume comprises an annular chamber.

5. The fuel nozzle system of claim 1, wherein the post-orifice comprises a primary soft passage.

6. The fuel nozzle system of claim 1, wherein the secondary fuel passage comprises a secondary soft passage.

7. The fuel nozzle system of claim 1, wherein the secondary fuel passage comprises a plurality of secondary fuel passages.

8. The fuel nozzle system of claim 1, wherein the post-orifice is positioned about a swirler.

9. The fuel nozzle system of claim 1, further comprising an intermittent or continuous flow of fuel in communication with the secondary fuel passage.

10. The fuel nozzle system of claim 1, further comprising a fuel/inert flow in communication with the secondary fuel passage.

11. A method of flowing fuel through a fuel nozzle system, comprising:
flowing the fuel across a first pressure drop in a first orifice;
flowing the fuel through a captured response volume;
flowing the fuel across a second pressure drop in a second orifice;
wherein the second pressure drop is less than the first pressure drop; and
flowing the fuel across a third pressure drop in a secondary passage;
wherein the third pressure drop is less than the second pressure drop.

12. The method of claim 11, further comprising flowing air through the fuel nozzle system.

13. The method of claim 12, wherein an overall pressure drop of the flowing fuel and the flowing air is substantially the same.

14. The method of claim 11, further comprising flowing a fuel/inert mixture in the secondary passage.

15. The method of claim 11, wherein the step of flowing the fuel across the third pressure drop in the secondary passage comprises inter intermittently or continuously flowing fuel in the secondary passage.

16. The method of claim 11, wherein the step of flowing the fuel across the third pressure drop in the secondary passage comprises flowing the fuel in a plurality of secondary passages.

17. A fuel nozzle system, comprising:
a first fuel orifice for a first pressure drop;
a captured response volume in communication with first fuel orifice;
a second fuel orifice in communication with the captured response volume for a second pressure drop;
wherein the second pressure drop is less than the first pressure drop; and
one or more secondary fuel passages downstream of the second fuel orifice for a third pressure drop;
wherein the third pressure drop is more or less than the second pressure drop.

18. The fuel nozzle system of claim 17, wherein the first fuel orifice comprises a plurality of first fuel orifices.

19. The fuel nozzle system of claim 17, wherein the second fuel orifice comprises a plurality of second fuel orifices.

20. The fuel nozzle system of claim 17, further comprising an intermittent or continuous flow of fuel in communication with the one or more secondary fuel passages.
